(19) United States
(12) Patent Application Publication
(10) Pub. No.: US 2015/0278799 A1
(43) Pub. Date: Oct. 1, 2015

(54) SYSTEM INCORPORATING WIRELESS SHARE PROCESS

(71) Applicant: KARTHIKEYAN PALANISAMY, Dublin, CA (US)

(72) Inventor: KARTHIKEYAN PALANISAMY, Dublin, CA (US)

(21) Appl. No.: 14/671,486

(22) Filed: Mar. 27, 2015

Related U.S. Application Data
(60) Provisional application No. 61/971,266, filed on Mar. 27, 2014.

(51) Int. Cl. G06Q 20/32; G06Q 20/20; G06Q 20/38; G06Q 20/36; H04W 12/04; H04W 84/18

(52) U.S. Cl. CPC G06Q 20/3278; H04W 12/04; H04W 84/18; G06Q 20/3821; G06Q 20/3674; G06Q 20/202; G06Q 2220/00

(57) ABSTRACT

Systems and methods for facilitating a user transaction are provided. A communication device may select an access device from a plurality of access devices. The communication device may establish a secure connection to the access device using a secure file transfer protocol supported by a wireless data protocol. The communication device may transmit a payment credential from the communication device to the access device using the secure file transfer protocol. The access device may broadcast a communication indicating connection readiness using the wireless data protocol. In response to receiving a request from the communication device, the access device may establish a secure connection with the communication device using the secure file transfer protocol. The access device may receive a payment credential via the secure file transfer protocol.

### CROSS-REFERENCES TO RELATED APPLICATIONS

This application is a non-provisional application of and claims the benefit of priority to U.S. Provisional Application No. 61/971,266, filed on Mar. 27, 2014, which is herein incorporated by reference in its entirety for all purposes.

### BACKGROUND

The use of a communication device to make payments has gained increased attention in the last few years as an alternative to carrying around physical payment cards. Applications running on the communication device allow users to electronically store their payment card (or other card) information in the software application. Many merchants have already implemented access devices (e.g., point-of-sale (POS) terminals) that allow a user to checkout using his/her communication device.

Some merchants now allow for payments to be conducted using near-field communication (NFC) technology. A conventional NFC transaction can be illustrated with reference to FIG. 9. In the conventional NFC transaction system, a mobile phone 910 may have a PAN (primary account number stored on it). The mobile phone 910 may be activated by a user operating it, and may then pass the mobile phone 910 by the POS terminal 920 using a first transceiver in the mobile phone 910. The PAN is typically transmitted to the POS terminal 920 in the clear, without any encryption. The POS terminal 920 then receives the PAN through a second transceiver. Usually, the mobile phone 910 must be located within 1-2 inches of the POS terminal 920 before it can receive the PAN. Once the POS terminal 920 receives the PAN from the mobile phone 910, it can process the transaction as a conventional payment card transaction.

While the conventional NFC system is useful, improvements can be made. For example, because the transmission of the PAN from the mobile phone to the POS terminal is in the clear, it is theoretically possible for an unauthorized person to obtain the PAN. Also, because the distance between the phone and the POS terminal must normally be 1-2 inches, the user of the phone must necessarily be physically very close to the POS terminal to conduct the transaction.

Embodiments of the invention address these and other problems.

### BRIEF SUMMARY

In some embodiments of the invention, systems and methods for facilitating a user transaction over a secure connection are provided. A user may approach a point-of-sale device and scan one or more items. The user may then interact with his/her communication device that may be enrolled with a digital wallet provider. The communication device may establish a secure connection to the point-of-sale device using a secure file transfer protocol that is supported by a wireless data protocol. The communication device may then transmit a payment credential (e.g., a payment token) to the access device using the secure file transfer protocol. The access device may then proceed with an authorization request message to an authorization computer (e.g., via an acquirer) including the payment credential received via the secure file transfer protocol.

Some embodiments of the invention are directed to a method including selecting, via a communication device, an access device. The method may also include establishing, via the communication device, a secure connection to the access device using a secure file transfer protocol supported by a wireless data protocol. The method may further include transmitting, via the communication device, a payment credential from the communication device to the access device using the secure file transfer protocol.

In some embodiments, the secure file transfer protocol is an ad-hoc service supporting transport layer security (TLS).

In some embodiments, the secure file transfer protocol is a device manufacturer specific protocol supporting transport layer security (TLS).

In some embodiments, the payment credential is a payment token.

In some embodiments, the token is encrypted using a hash value generated from a user password associated with a digital wallet application on the communication device.

Some embodiments of the invention are directed to a method including broadcasting, via an access device (e.g., POS terminal) device, a communication indicating connection readiness using a wireless data protocol. The method also includes, in response to a request from a mobile device, establishing, via the access device, a secure connection to the mobile device using a secure file transfer protocol supported by the wireless data protocol. The method further includes receiving, via the access device and from the mobile device, a payment credential using the secure file transfer protocol.

Other embodiments of the invention are directed to communication devices, servers, and systems that are configured to perform the above-described methods.

These and other embodiments of the invention are described in further detail below.

### BRIEF DESCRIPTION OF THE DRAWINGS

FIG. 1 shows a block diagram of a typical transaction processing system, in accordance with some embodiments of the invention.

FIG. 2 shows a block diagram of a communication device, in accordance with some embodiments of the invention.

FIG. 3 shows a block diagram of an access device, in accordance with some embodiments of the invention.

FIG. 4 shows a flowchart of a method of establishing a connection between a communication device and an access device using a secure file transfer protocol, in accordance with some embodiments of the invention.

FIG. 5 shows a flow diagram of a user transaction involving various payment entities in a transaction processing system, in accordance with some embodiments of the invention.

FIG. 6 shows a flow diagram of the process of establishing a secure connection between a communication device and an access device, in accordance with some embodiments of the invention.

FIG. 7A shows an exemplary interface on a communication device for selecting an access device to facilitate a transaction using a secure file transfer protocol, in accordance with some embodiments of the invention.

FIG. 7B shows an exemplary interface on an access device for confirming a secure file transfer with a communication device over a secure file transfer protocol, in accordance with some embodiments of the invention.

FIG. 8 shows exemplary computer apparatus, in accordance with some embodiments of the invention.

FIG. 9 shows an exemplary prior art system for a transaction using NFC.

### DETAILED DESCRIPTION

Prior to discussing embodiments of the invention, descriptions of some terms may be helpful in understanding embodiments of the invention.

An “authorization request message” may be an electronic message that is sent to an authorization system such as a payment processing network and/or an issuer computer to request authorization for a transaction. An authorization request message is an example of a transaction message. An authorization request message according to some embodiments may comply with ISO 8583, which is a standard for systems that exchange electronic transaction information associated with a payment made by a consumer using a payment device or a payment account. The authorization request message may comprise a primary account number (PAN), expiration date, service code, CVV and other data from a payment device. In some embodiments of the invention, an authorization request message may include a payment token (e.g., a substitute or pseudo account number), an expiration date, a token presentment mode, a token requestor identifier, an application cryptogram, and an assurance level data. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, by way of example only: a service code, a CVV (card verification value), a dCVV (dynamic card verification value), an expiration date, etc.

An “authorization response message” may be an electronic message reply to an authorization request message generated by the authorization system. The authorization response message may include an authorization code, which may be a code that the authorization system returns in response to receiving an authorization request message (either directly or through the payment processing network). The authorization response message is received at the merchant's access device (e.g. POS terminal) and can indicate approval or disapproval of the transaction by the authorization system.

A “secure file transfer protocol” can include a network protocol that provides file access, file transfer, and file management functionalities over any reliable data stream. The protocol may run over a secure channel. An example of a secure file transfer protocol is Transport Layer Security (TLS). It ensures privacy between communicating applications and their users. Another secure file transfer protocol may include SSL (Secure Sockets Layer). The secure file transfer protocol may allow devices to transmit or receive data wirelessly between two devices in a peer-to-peer manner. In some embodiments, the secure file transfer protocol can allow for the transfer of data between two devices separated by a distance of 10 meters or less. In this regard, the secure file transfer protocol may utilize Wi-Fi™ or Bluetooth™. Typically, the secure file transfer protocol does not provide for the transfer of data when two devices are separated from each other by large distances (e.g., distances greater than 100 yards).

A “server computer” may be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer.

An “access device” can include a device that allows for communication with a remote computer, and can include a device that enables a customer makes a payment to a merchant in exchange for goods or services. An access device can include hardware, software, or a combination thereof. Examples of access devices include point-of-sale (POS) terminals, mobile phones, tablet computers, laptop or desktop computers, etc.

A “virtual wallet” or “digital wallet” may refer to an electronic device that allows an individual to make electronic commerce transactions. This can include purchasing items on-line with a computer or using a communication device (e.g., smartphone) to purchase an item at a physical store. The “virtual wallet” or “digital wallet” can consist of the system (the electronic infrastructure), the application (the software that operates on top), and the device (the individual portion). An individual's bank account can also be linked to the virtual wallet. The individual may also have their driver's license, health card, loyalty card(s), and other ID documents stored within the virtual wallet.

A “virtual wallet provider” or “digital wallet provider” may include any suitable entity that provides a virtual wallet service or digital wallet service. A virtual wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the virtual wallet.

“Contactless” or “wireless” can include any communication method or protocol, including proprietary protocols, in which data is exchanged between two devices without the need for the two devices to be physically coupled. For example, “contactless” or “wireless” can include radio frequency (RF), infrared, laser, or any other communication means, and the use of any protocols, such as proprietary protocols, with such communication means.

A “payment token” or a “token” may include any identifier for a payment account that is a substitute for an account identifier. For example, a token may include a series of alphanumeric characters that may be used as a substitute for an original account identifier. For example, a token “4900 0000 0000 0001” may be used in place of a primary account identifier or primary account number (PAN) “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “wireless data protocol” can include a technical standard for accessing information over a wireless network. Some examples of wireless data protocols include, but are not limited to, Wi-Fi, Bluetooth, NFC, etc.

### I. Exemplary Systems

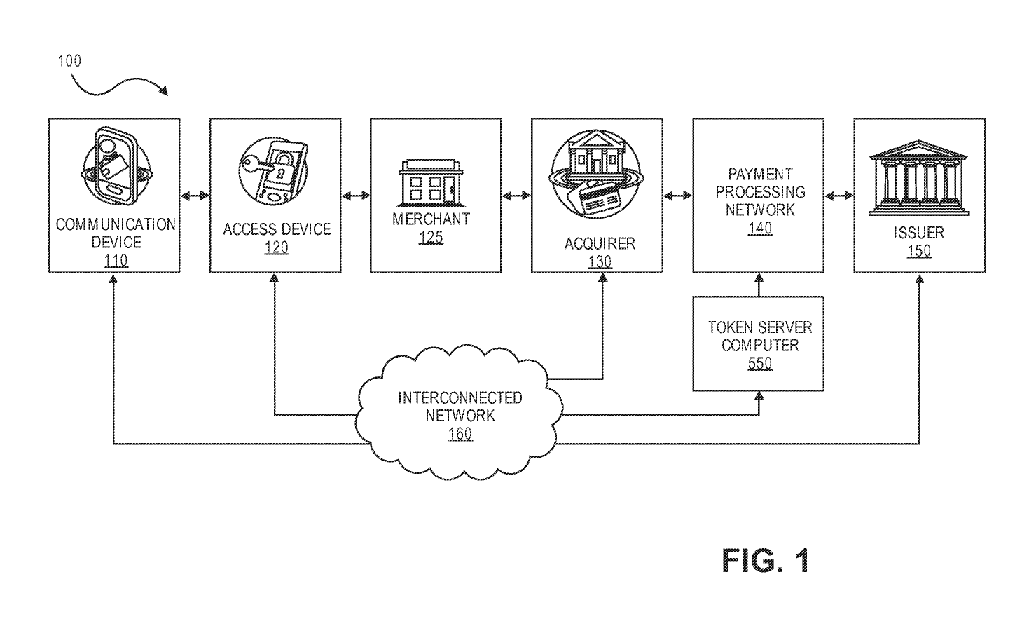

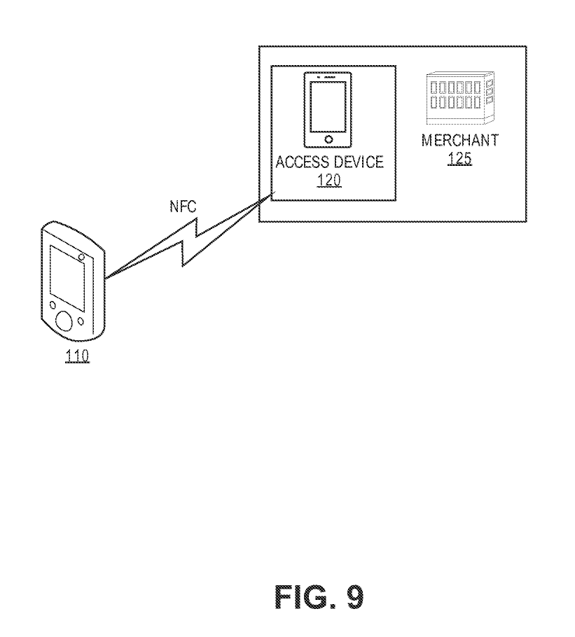

FIG. 1 shows a block diagram of a typical transaction processing system 100. The system 100 may include a communication device 110, an access device 120, a merchant computer 125, an acquirer computer 130, a payment processing network computer 140, an issuer computer 150, and a token server computer 550. In some implementations, different entities in FIG. 1 may communicate with each other using one or more communication networks such as the Internet, a cellular network, a TCP/IP network or any other suitable communication network. Note that one or more entities in the system 100 may be associated with a computer apparatus that may be implemented using some of the components as described with reference to FIG. 9.

The communication device 110 may be associated with a payment account of a user. In some implementations, the communication device 110 may be a mobile device such as a mobile phone, a tablet, a PDA, a notebook, a key fob or any suitable mobile device. In some embodiments, the communication device 110 may be a wearable device such as, but not limited to, a smart watch, a fitness band, an ankle bracelet, a ring, earrings, etc. For example, the communication device 110 may include a virtual wallet or a payment application that may be associated with one or more payment accounts of the user. In some implementations, the communication device 110 may be capable of communicating with the access device 120 using a wireless data protocol such as Wi-Fi™ or Bluetooth™. For example, the communication device 110 may interact with the access device 120 by establishing a connection with the access device 120 using a wireless data protocol.

The access device 120 may be an access point to a transaction processing system that may comprise the acquirer computer 130, the payment processing network computer 140, and the issuer computer 150. In some implementations, the access device 120 may be associated with or operated by the merchant computer 125. For example, the access device 120 may be a point of sale device that may include a contactless reader, an electronic cash register, a display device, etc. In some implementations, the access device 120 may be configured to transmit information pertaining to one or more purchased items at a merchant 125 to an acquirer 130 or payment processing network 140. In some implementations, the access device 120 may be a personal computer that may be used by the user to initiate a transaction with the merchant computer 125 (e.g., an online transaction).

The acquirer computer 130 may be operated by an acquirer. The acquirer is typically a system for an entity (e.g., a bank) that has a business relationship with a particular merchant, a wallet provider or another entity. The acquirer computer 130 may be communicatively coupled to the merchant computer 125 and the payment processing network 140 and may issue and manage a financial account for the merchant. The acquirer computer 130 may be configured to route the authorization request for a transaction to the issuer computer 150 via the payment processing network computer 140 and route an authorization response received via the payment processing network computer 140 to the merchant computer 125.

The payment processing network computer 140 may be configured to provide authorization services, and clearing and settlement services for payment transactions. The payment processing network computer 140 may include data processing subsystems, wired or wireless networks, including the internet. An example of the payment processing network computer 140 includes VisaNet™, operated by Visa®. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. The payment processing network computer 140 may include a server computer. In some implementations, the payment processing network computer 140 may forward an authorization request received from the acquirer computer 130 to the issuer computer 150 via a communication channel. The payment processing network computer 140 may further forward an authorization response message received from the issuer computer 150 to the acquirer computer 130.

The issuer computer 150 may represent an account issuer and/or an issuer processor. Typically, the issuer computer 150 may be associated with a business entity (e.g., a bank) that may have issued an account and/or payment card (e.g., credit account, debit account, etc.) for payment transactions. In some implementations, the business entity (bank) associated with the issuer computer 150 may also function as an acquirer (e.g., the acquirer computer 130).

The issuer computer 150 and/or the payment processing network computer 140 may operate as authorization systems in some embodiments of the invention.

The token server computer may be configured to provide tokenization services such as token provisioning, token generation, token validation, etc.

The various entities in the system 100 may communicate with each other via an interconnected network 160, e.g., the Internet.

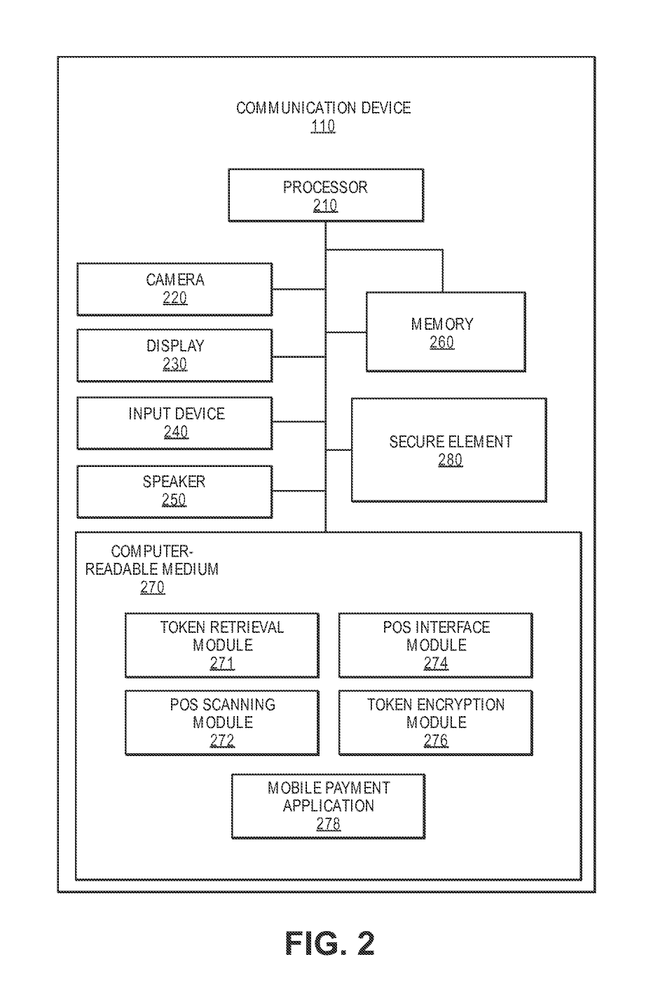

FIG. 2 shows a block diagram of a communication device 110, in accordance with some embodiments of the invention. Communication device 110 includes a processor 210, a camera 220, a display 230, an input device 240, a speaker 250, a memory 260, a computer-readable medium 270, and a secure element 280.

Processor 210 may be any suitable processor operable to carry out instructions on the communication device 110. The processor 210 may comprise a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Core, Atom, Celeron, Itanium, Pentium, Xeon, and/or XScale; and/or the like processor(s). The processor 210 is coupled to other units of the communication device 110 including camera 220, display 230, input device 240, speaker 250, memory 260, and computer-readable medium 270.

Camera 220 may be configured to capture one or more images via a lens located on the body of communication device 110. The captured images may be still images or video images. The camera 220 may include a CMOS image sensor to capture the images.

Display 230 may be any device that displays information to a user. Examples may include an LCD screen, CRT monitor, or seven-segment display.

Input device 240 may be any device that accepts input from a user. Examples may include a keyboard, keypad, mouse, or microphone. In the case of a microphone, the microphone may be any device that converts sound to an electric signal. In some embodiments, the microphone may be used to capture one or more voice segments from a user for user authentication.

Speaker 250 may be any device that outputs sound to a user. Examples may include a built-in speaker or any other device that produces sound in response to an electrical audio signal.

Memory 260 may be any magnetic, electronic, or optical memory. It can be appreciated that memory 260 may include any number of memory modules. An example of memory 260 may be dynamic random access memory (DRAM).

Computer-readable medium 270 may be any magnetic, electronic, optical, or other computer-readable storage medium. Computer-readable storage medium 270 includes token retrieval module 271, POS scanning module 272, POS interface module 274, and token encryption module 276. Computer-readable storage medium 270 may comprise any combination of volatile and/or non-volatile memory such as, for example, buffer memory, RAM, DRAM, ROM, flash, or any other suitable memory device, alone or in combination with other data storage devices.

Token retrieval module 271 may comprise code that when executed by processor 210, can cause the token retrieval module 271 to retrieve a token from a digital wallet provider or token generator. The token may be associated with a PAN associated with a primary account of the user of the communication device 110. The token retrieval module 271 may interact with the digital wallet provider or token generator using a token requestor interface for the generation, use and management of tokens. In some embodiments, communication device 110, via token retrieval module 271, may have to undergo an onboarding or registration process to ensure that the communication device meets integration and security standards in order to use the tokenization services provided by the digital wallet provider or token generator. For example, the digital wallet provider or token generator may provide services such as card registration, token generation, token issuance, token authentication and activation, token exchange, and token life-cycle management to the registered entities (e.g., communication device 110).

POS scanning module 272 may comprise code that when executed by processor 210, can cause the POS scanning module 272 to scan for available POS terminals within a vicinity of the communication device 110. The POS scanning module 272 may use a wireless data protocol to perform the scanning. The POS terminals may broadcast their availability to establish a secure connection and the POS scanning module 272 may scan for these broadcasts to determine which POS terminals within the vicinity of the communication device 110 are available.

POS interface module 274 may comprise code that when executed by processor 210, can cause the POS interface module 274 to establish a secure connection to a POS terminal. The POS interface module 274 may establish the secure connection to one of the POS terminals discovered by the POS scanning module 272, as described above. The secure connection may be established by using a wireless data protocol supported by both the communication device 110 and the POS terminal. In some embodiments, the POS interface module 274 may establish a secure connection to a POS terminal selected by the user from a list of available POS terminals. The POS interface module 274 may also transmit and receive payment transaction related data to and from the POS terminal, via the wireless data protocol and a transceiver (not shown).

Mobile payment application 278 may be an application that allows a user of the communication device 110 to initiate a payment transaction. It may be associated with a payment processor, an issuer, or digital wallet. When conducting a purchase transaction, the mobile payment application 278 may be executed, and account numbers or account number aliases may be displayed to the user to use for payment.

Secure element 280 can be a secure memory and execution environment. The secure element 280 may be a dynamic environment in which application code and application data can be securely stored and administered and in which secure execution of applications occur. The secure element 280 may reside in highly secure crypto chip (e.g., a smart card chip). The secure element 280 could be implemented either by a separate secure smart card chip, in the Subscriber Identity Module/Universal Integrated Circuit Card (SIM/UICC) (which is used by GSM mobile phone operators to authenticate subscribers on their networks and maintain personalized subscriber information and applications), or in an SD card that can be inserted in the communication device 110. In some embodiments, the token retrieved by the token retrieval module 271 may be stored within the secure element.

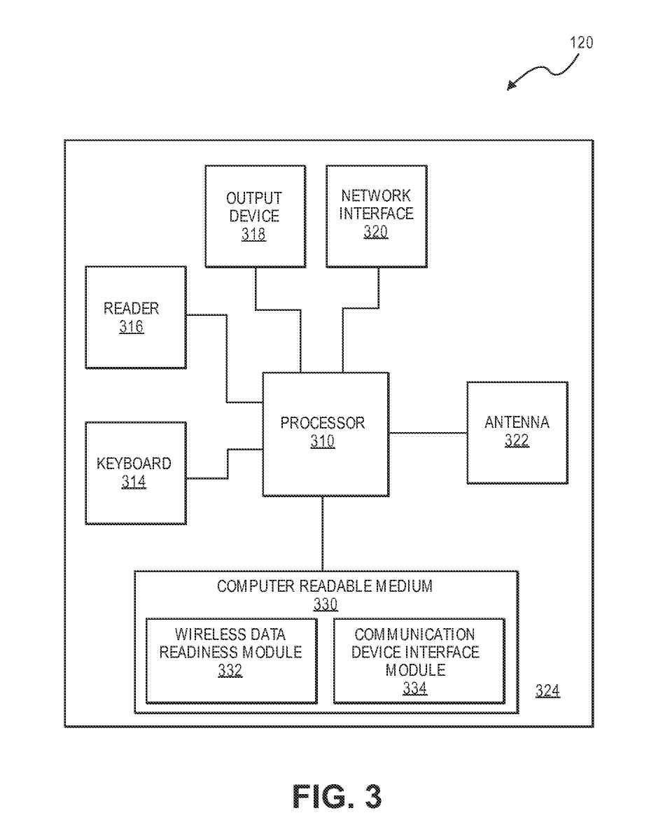

FIG. 3 shows a block diagram of an access device 120, in accordance with some embodiments of the invention. Access device 120 may comprise a processor 310. The processor 310 may be the same or different type of process as the processor 210 described above. It may also comprise a computer-readable medium 330, a keyboard 314, a magnetic strip reader 316, an output device 318, a network interface 320, and an antenna 322. All of these elements may be operatively coupled to processor 310. A housing 324 may also house one or more of these components. Examples of the access device 120 include, but is not limited to, a point-of-sale (POS) terminal.

Computer-readable medium 330 may include one or more memory chips, disk drives, etc. Computer-readable medium 330 may store code or instructions for allowing merchant access device 120 to operate in the manner described herein. The instructions may be executed by processor 310. Computer-readable medium 312 may further comprise any suitable modules.

Wireless data readiness module 332, in conjunction with the processor 310, may cause the access device 120 to broadcast (via antenna 322) its availability to establish a secure connection with a communication device 110. The broadcast may be sent via a wireless data protocol supported by both the access device 120 and the communication device 110. The broadcast may be transmitted continuously or at predefined intervals (e.g., every 10 seconds).

Communication device interface module 334, in conjunction with the processor 310, may cause the access device 120 to establish a secure connection with a communication device 110 and communicate with the access device 120 over the secure connection. The secure connection may be established over a wireless data protocol supported by both the access device 120 and the communication device 110. The communications may occur via the antenna 322.

Keyboard 314 may be operable to input information such as transaction information into access device 120. Magnetic strip reader 316 may be operable to read information from a magnetic strip of a card such as a credit or a debit card. Output device 318 may include a display. The display may display, for example, transaction information. Network interface 320 may be operable to enable access device 120 to communicate with other system entities. For example, it may enable access device 120 to communicate with one or more of acquirer 130, payment processing network 140, and issuer 150. Antenna 322 may be provided to enable access device 120 to operate remotely.

The systems and methods described herein with respect to facilitating a user transaction over a secure file transfer protocol can be further understood in the following illustrative examples.

### II. Facilitating a Transaction Over a Secure Connection

Embodiments of the invention allow for facilitating a transaction using a secure file transfer protocol. An example of a suitable secure file transfer protocol is Airdrop™ from Apple®. As described above, the current implementations for making payments at an access device using a communication device are not secure, because the data transfer protocols (e.g., NFC) being used send payment data “in the clear”. Additionally, the existing data transfer protocols are slow and require a user's communication device to be in not more than a few inches away from the access device in order for the data transfer of payment credentials to occur successfully.

These problems can be solved by using a secure file transfer protocol to transfer the payment credentials from the communication device to the access device. The wireless data transfer protocol that allows for transferring data wirelessly from one device to another device (e.g., from a communication device 110 to an access device). The wireless data protocol uses a short range wireless communication system such as Bluetooth® to create a peer-to-peer Wi-Fi (e.g., Wi-Fi Direct) network between two devices. Each device creates a firewall (e.g., a virtual private network) around the connection and data is sent encrypted, which increases security of the transferred data. Additionally, the wireless data transfer protocol may automatically detect nearby devices that support the protocol. Using wireless data transfer protocol to transfer payment credentials during a payment transaction provides many technical advantages, some of which are listed below.

First, the data transfer of the payment credentials between the communication device and the access device is more secure with the wireless data transfer protocol, because it protocol creates a secure virtual private network between the two devices. Data sent over this virtual private network is encrypted and not susceptible to eavesdropping from a fraudster, as is the case with NFC.

Second, the user can initiate the payment transaction from a further distance away from the access device than he/she can by using NFC. Since the wireless data transfer protocol creates a peer-to-peer Wi-Fi connection between the devices, the devices only need to be close enough to establish a reliable Wi-Fi connection. Thus, the wireless data transfer protocol allows data to be transferred at greater distances than with NFC. In an example, a user may pick up an item at a merchant store and initiate a transaction with a merchant access device without leaving his current location or having to physically walk over to the access device.

Third, since the interaction between a mobile phone and an access device is very brief, only a very limited amount of data can pass between the mobile phone and the access device in an NFC transaction. Typically, only payment credentials such as a PAN can pass from the phone to the access device. In embodiments of the invention, however, more data can be passed between the access device and the phone to provide the user with an improved transaction experience and/or to make the transaction more secure. For example, using the wireless data transfer protocol, the phone may provide a coupon and the PAN to the access device in a single data transmission. The access device may process the transaction using the coupon and the PAN. For example, the access device could apply a discount to the current transaction using the coupon, and could generate an authorization request message that requests authorization for a transaction with the discounted amount. In another example, the access device, could receive a device ID from the mobile phone along with the PAN. The device ID may be used as authentication data to authenticate the mobile device conducting the transaction. The access device and/or a remote server could perform the authentication process.

Fourth, the data transfer rate using AirDrop® is faster because AirDrop uses Wi-Fi which is comparatively faster than the data transfer rate over NFC or Bluetooth, increasing the customer experience during a transaction.

Embodiments of the invention also allow for using NFC to initiate a wireless data transfer protocol connection between a communication device and an access device. For example, NFC may be used to initiate an initial connection between the access device and the communication device, for instances where a merchant may want to require that a user is physically present in front of an access device. Once the NFC connection is established it may indicate that the user is in front of the access device, since NFC requires very close proximity between the devices to establish a connection. At this point, a wireless data transfer protocol connection may be established between the communication device and the access device to securely transfer the payment credentials for the payment transaction.

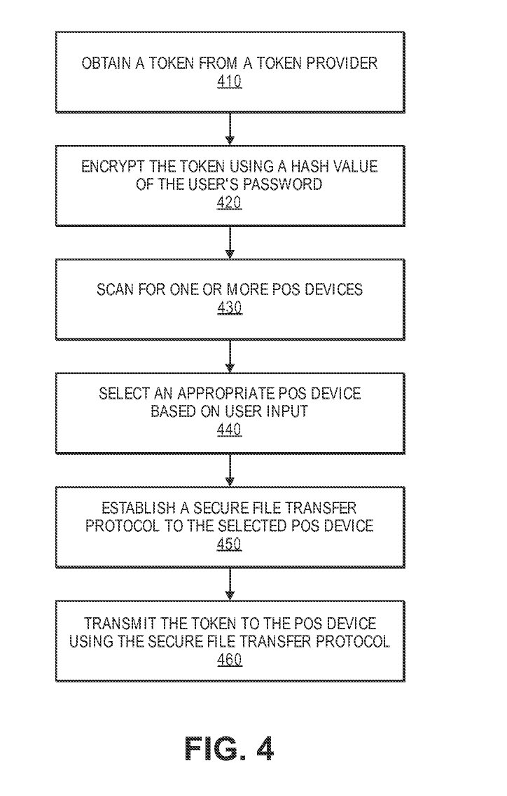

FIG. 4 shows a flowchart of a method of establishing a connection between a communication device and a POS terminal using a secure file transfer protocol, in accordance with some embodiments. The method can be performed by processing logic that may comprise hardware (circuitry, dedicated logic, etc.), software (such as is run on a general purpose computing system or a dedicated machine), firmware (embedded software), multiple systems or any combination thereof.

In block 410, a token is obtained by the communication device from a token provider. The token may be provided to the communication device after a user launches a payment application stored on the communication device. In some embodiments, the token provider may be a digital wallet provider or a token generator. The token may be obtained by the communication device 110. The communication device 110 may initiate the request to the token provider and provide data in the request that may be needed in order to obtain the token. This data may include, but is not limited to, information pertaining to the user of the communication device, authentication information, account information, etc. In some embodiments, the user may have previously engaged in an enrollment process to enroll his/her payment card with the token provider. Upon verifying the authenticity of the token request, the token provider may provide the token to the communication device 110. For example, the token provider may operate a token provider computer and may transmit the token over the air to the communication device 110. The token may be associated with a primary account number (PAN) associated with the user's payment account. The token may be obtained via the token retrieval module 271.

In block 420, after the token is obtained by the communication device 110 from the token provider, the token may be encrypted using a hash of the user's password associated with a digital wallet application (or other payment application) running on the communication device 110. In other embodiments, other data other than the hash of the user's password can be used to encrypt the token. For example, a device identifier associated with the communication device 110, a personal identification number, birthday, mailing address, or hashes thereof may be used to encrypt the token in other embodiments of the invention. The token may be encrypted using any encryption algorithm. Suitable encryption algorithms may include DES, triple DES, and AES. The token may be encrypted by the token encryption module 276. Block 420 may be optional as it is possible to receive the token already encrypted from the token provider.

In block 430, after the token is encrypted, the communication device may scan for one or more available POS terminals (e.g., access devices). The scanning may be performed by the POS scanning module 272 using a wireless data protocol supported by both the communication device 110 and the POS terminal. The POS scanning module 272 may scan for a broadcast by the POS terminal using the wireless data protocol. The broadcast may indicate that the POS terminal is in the vicinity of the communication device 110 and is available to establish a secure connection. After scanning for available POS terminals, the communication device 110 may provide a list of the available POS terminals to the user, via the display 230. Alternatively, the POS terminal may enter a “listening mode” after the user scans his/her items at the POS terminal for checkout. In some embodiments, the POS terminal may be a mobile POS terminal.

The user may indicate with the communication device 110 which POS terminal he/she wishes the communication device 110 establish a secure connection with, for purposes of completing a payment transaction. At this time, the payment credentials and any other data to be shared with the POS terminal may be shown to the user by the communication device 110 so that it is clear to the user what data is being transferred. In some cases, the POS terminal that is near the user may have an identifier visible to the user (e.g., a terminal ID such as “Terminal X” may be on a label on the POS terminal), so that the user knows which POS terminal to select and establish a secure connection. In other embodiments, the communication device 110 may automatically select the POS terminal determined to be closest to the communication device 110. This may be accomplished using well-known location-determination techniques in the art. In some embodiments, the scanning may be performed after a user scans his/her items for purchase at the POS terminal.

In block 440, after scanning for the available POS terminals, the communication device 110 may select an appropriate POS terminal based on the user's selection (or automatically as described above). The communication device 110 may then prepare to establish a secure connection to the selected POS terminal. In some cases, the POS terminal may display a prompt to its user which asks if the user wants to connect the POS terminal to the communication device 110.

In block 450, after selecting an appropriate POS terminal, the communication device 110 may establish a secure connection to the POS terminal using a secure file transfer protocol (e.g., part of a wireless data protocol). The secure connection may be established via the POS interface module 274. In some embodiments, the secure file transfer protocol may be an ad-hoc service. For example, the communication device 110 may establish a secure connection the POS terminal. The wireless data protocol may be supported by both the communication device 110 and the POS terminal. In some embodiments, a handshaking sequence may occur between the communication device 110 and the POS terminal prior to establishing the secure connection.

In block 460, after establishing a secure connection to the POS terminal using a secure file transfer protocol, the communication device may transmit the token and any other suitable data to the POS terminal using the secure file transfer protocol. For example, the communication device 110 may transmit the token and any other suitable data to the POS terminal using AirDrop®. The POS interface module 274 may facilitate the transmission of the token to the POS terminal. The POS terminal may then carry out the payment transaction using the received token. In some embodiments, the token may be unencrypted by the communication device 110 prior to sending it to the POS terminal. In some embodiments, the POS terminal may forward the token to an acquirer, a payment processing network and/or an issuer for further processing.

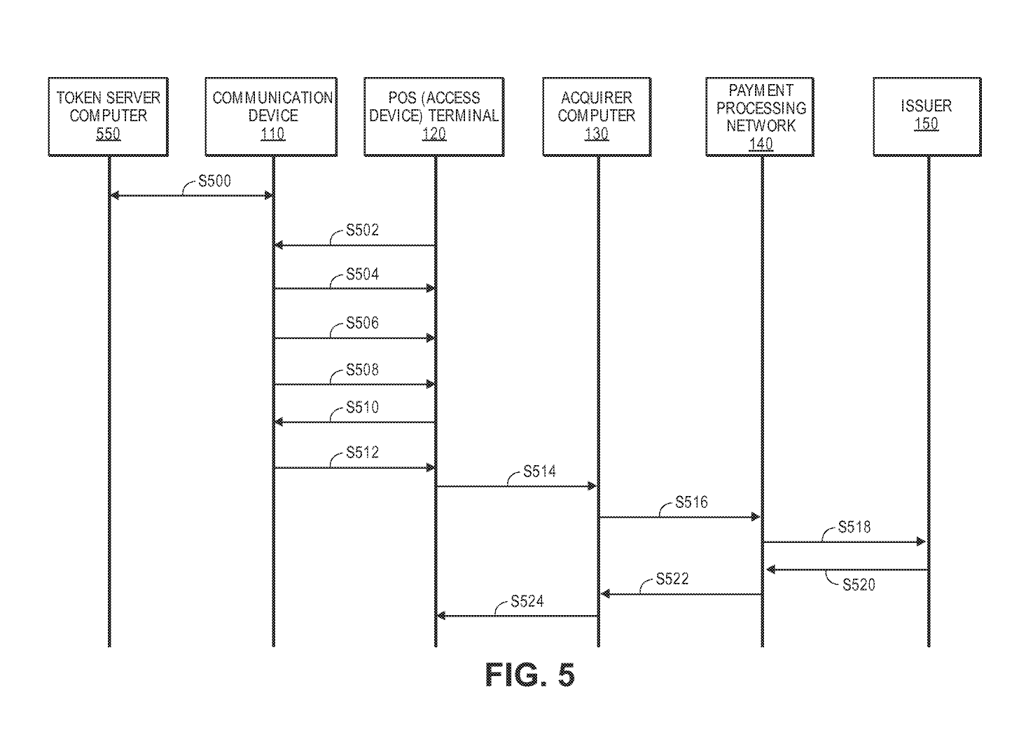

FIG. 5 shows a flow diagram of a user transaction involving various payment entities in a transaction processing system, in accordance with some embodiments of the invention. The various payment entities include a token server computer 550 (e.g., payment processing network server), a communication device 110, an access device 120 (e.g., POS terminal), an acquirer computer 130, a payment processing network 140, and an issuer 150.

At step s500, the communication device 110 may retrieve a token from the token server computer 550 (e.g., token provider, token generator, digital wallet provider, etc.). The communication device 110 may retrieve the token from the token server computer 550 once a user launches a payment application on the communication device 110. The token server computer 550 may be remotely located with respect to the communication device 110 and may communicate with the communication device 110 using any suitable communications network. The communication device 110 and the user's payment account may have been previously enrolled with the token server computer, by the user. In some embodiments, the token server computer 550 may be part of the issuer network. In other embodiments, the token server computer 550 may be a separate third-party. In some embodiments, the communication device 110 may encrypt the token prior to storing it within a secure element 280.

At step s502, the access device 120 may broadcast a communication over a wireless data protocol indicating that the access device 120 is ready to establish a secure connection with a communication device 110. The wireless data protocol may be supported by both the communication device 110 and the access device 120. In other embodiments, instead of broadcasting a communication, the access device 120 may enter a “listening mode” where the access device 120 readies itself to accept a secure connection from the communication device 110.

At step s504, the communication device 110 may scan for one or more available POS terminals. The scanning may be performed using a wireless data protocol supported by both the communication device 110 and the access device 120. The scanning may include scanning for any communications being broadcast by one or more of the access devices 120.

At step s506, the communication device 110 may select an appropriate POS terminal based on input received from the user. That is, the user may choose from a list of available access devices presented by the communication device 110, which access device to establish a secure connection with (e.g., the access device that the user is closest to. In other embodiments, the communication device 110 may select the access device at which the user scans his/her items for checkout and which enters the “listening mode” described above. In some embodiments, the selection of the appropriate POS terminal may be performed automatically by the communication device 110. In some embodiments, the access device 120 may display a notification asking the user (e.g., a store clerk) of the access device 120 wants to connect with the communication device 110.

At step s508 and s510, the communication device 110 and the access device 120 may establish a secure connection to one another, using a secure file transfer protocol. In some embodiments, the communication device 110 and the access device 120 may undergo a handshaking procedure prior to establishing the secure connection.

At step s512, the communication device 110 may send the payment credential and/or other payment data to the access device 120 over the secure connection. That is, the payment credential and/or other payment data may be transmitted to the access device 120 using the secure file transfer protocol. The payment credential in some embodiments of the invention may be a payment token. It can be appreciated that the transmission may include error correction to ensure that the payment credential is received accurately.

At step s514, the access device 120 may forward the payment credential along with other information pertaining to the transaction to the acquirer computer 130 in the form of an authorization request message. At steps s516 and s518, the acquirer computer may forward the authorization request message to the issuer 150 for authorization, via the payment processing network 140. At step s520, the issuer may either approve or deny the transaction based on a number of criteria well-known in the art. At step s522, the issuer computer may transmit an authorization response message to the acquirer computer 130, via the payment processing network 140. At step s524, the acquirer computer 130 may notify the access device 120 about the outcome of the transaction authorization. The access device 120 may notify the user, either directly or by sending a communication to the communication device 110, of the result of the transaction.

At the end of the day, a clearing and settlement process may occur between the acquirer computer 130, the payment processing network 140, and the issuer computer 150.

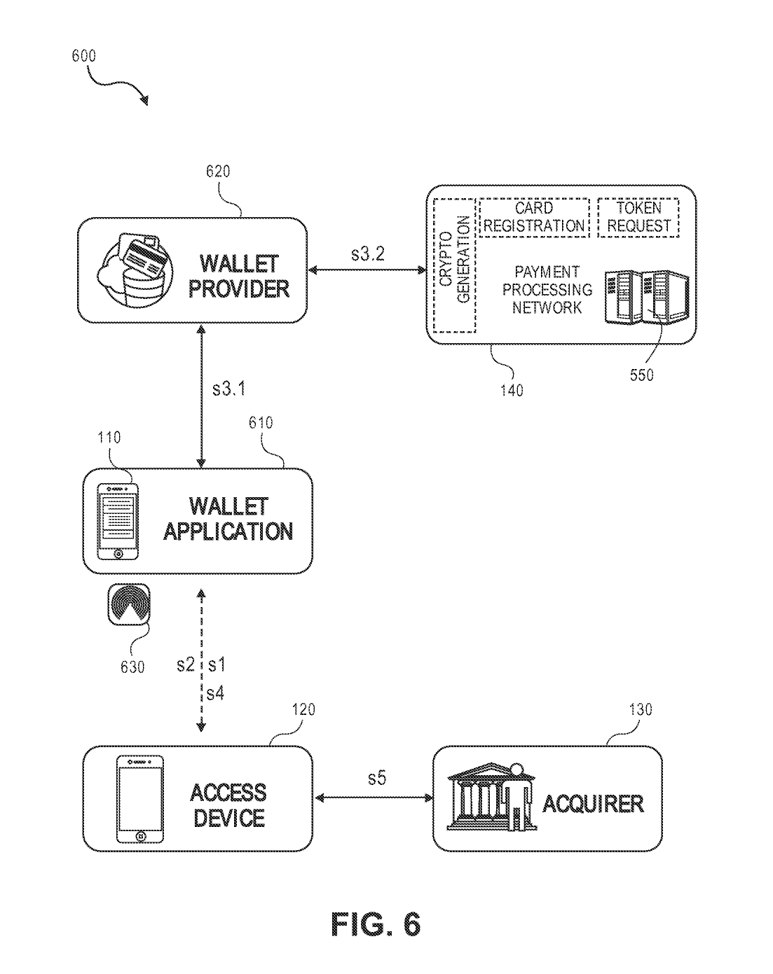

FIG. 6 shows a flow diagram of the process of establishing a secure connection between a communication device and a POS terminal, in accordance with some embodiments of the invention. The payment transaction system 100 includes a wallet application 610, wallet provider 620, access device 120, payment processor network server 550, and acquirer 130. In some embodiments, the wallet application 610 may be a digital wallet application running on the communication device 110 (e.g., a mobile phone, tablet, etc.). The access device 120 may be a mobile POS or a stationary or permanent POS terminal.

At some point, a user may have enrolled his/her communication device 110 with the wallet provider 620. The enrollment may also include enrollment of the user's payment card with the wallet provider 620. The payment card may be associated with a primary account number (PAN). During enrollment, the wallet provider 620 may register the user's payment card with the payment processing network server 550 and request for a token. The token may be generated by the payment processing network server 550 and associated with the user's PAN. Additionally, the token may be encrypted using a hash value generated from the user's password, as described above. Upon receiving the token from the payment processing network server 550, the wallet provider 620 may store the encrypted token.

At step s1, one or more products and/or services may be scanned at the access device 120 (e.g., a mobile POS). For example, the mobile POS may be located at a grocery store and the user (or employee of the grocery store) may scan grocery items for checkout at the mobile POS. The mobile POS may then present one or more payment options to the user. One of these payment options may be the option to pay using the communication device 110 via a secure file transfer protocol 630. If the user elects to use the secure file transfer protocol, the mobile POS may enter a listening mode associated with the secure file transfer protocol 630. Alternatively, the mobile POS may already have been broadcasting a message indicating readiness to accept a secure connection which may be scanned by the communication device 110.

At step s2, wallet application 610 may be executed on the communication device 110 for purposes of facilitating the transaction using the secure file transfer protocol 630. The wallet application 610 may scan for one or more POS terminals (e.g., access device 120 that are in the listening mode associated with the secure file transfer protocol 630. Upon scanning the POS terminals, the wallet application 610 may provide a list of the detected POS terminals that are in the listening mode associated with the secure file transfer protocol 630. The user may select the appropriate mobile POS from the list of POS terminals. In some embodiments, the wallet application 610 may automatically select the mobile POS based on one or more criteria, e.g., the closest POS within vicinity of the communication device 110.

At steps s3.1 and s3.2, the wallet application 610 may retrieve payment credentials (e.g., dCVV/Track-2 data) from the payment processing network server 550, via the wallet provider 620. The wallet application 610 may have access to this data since the communication device 110 may be enrolled with the wallet provider 620, as described above.

At step s4, based on the selection of the mobile POS in step s2, the wallet application 610, via communication device 110, may establish a secured connection (e.g., transport layer security (TLS) connection) with the mobile POS. The wallet application 610 may then transmit the user's payment credentials to the mobile POS using the secured connection. In some embodiments, the transmission of the payment credentials may be sent in a single encrypted packet. The payment credentials may include the token and a unique cryptogram generated for the particular transaction. In some embodiments, the connection may be facilitated using Bluetooth or other wireless communication protocols such as Wi-Fi. In some embodiments, the secured connection may be facilitated via AirDrop®.

At step s5, the mobile POS may submit the transaction to the acquirer 130 for authorization. At this point, a typical payment authorization flow may occur. For example, the acquirer computer 130 may communicate with the payment processing network, which in turn may communicate with an issuer to authorize the transaction.

At the end of the day, a clearing and settlement process may occur between the acquirer computer 130, the payment processing network 140, and the issuer computer 150.

In the above transaction flow, the payment credentials may not need to be stored on the communication device 110 in some embodiments. Rather, upon each transaction, the communication device 110 may obtain the payment credentials from the wallet provider 620 as described above. Additionally, upon each transaction, a unique cryptogram may be generated. The cryptogram information could be defined for the specific transaction type (e.g., transaction using secure file transfer protocol). That is, the generated cryptogram may be specific to transactions using the secure file transfer protocol.

The above transaction flow may allow smaller merchants (where mobile POS terminals may be more feasible than traditional permanent POS terminals) to conduct transactions in a secure manner.

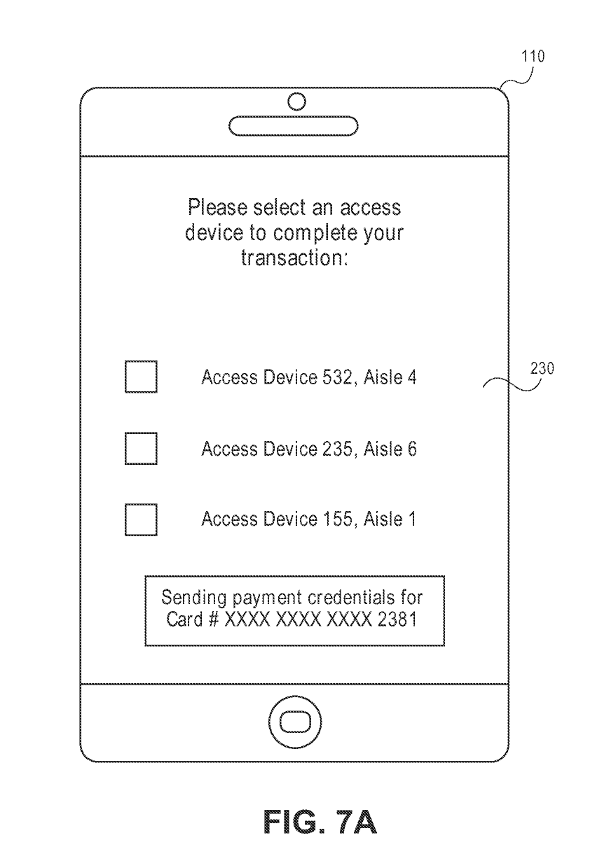

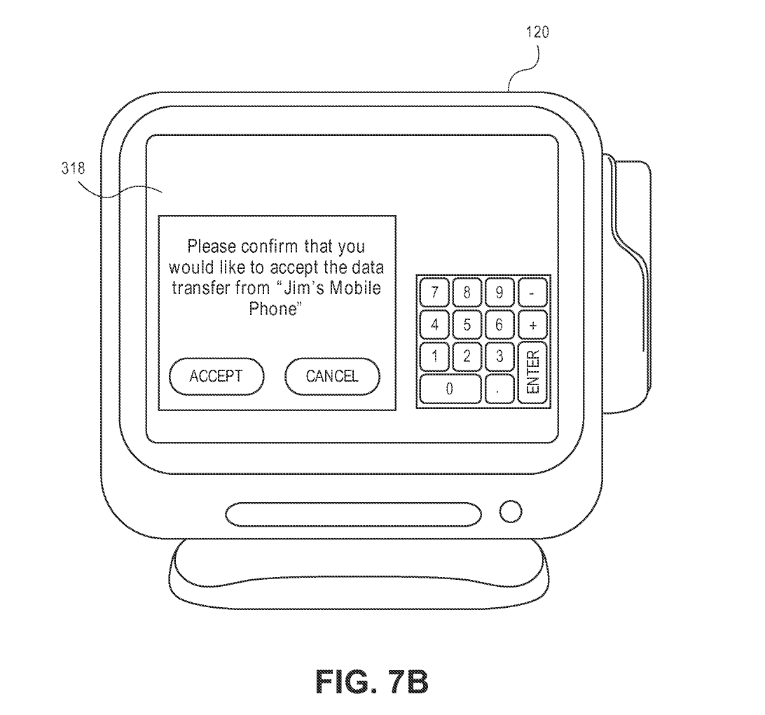

FIG. 7A shows an exemplary interface on a communication device 110 for selecting an access device to facilitate a transaction using a secure file transfer protocol, in accordance with some embodiments of the invention. FIG. 7A shows a communication device 110 having a display 230. The display 230 may display a graphical user interface (GUI) which the user of the communication device 110 may interact with to select an access device 120 for initiating a payment transaction. For example, a user may open up a payment application on his/her communication device 110 once the user has selected the items or services from the merchant he/she wishes to purchase. The payment application may use the wireless data transfer protocol to scan for available access devices 120 that support the wireless data transfer protocol. Once the scan is complete, the GUI being shown on the display 230 may present the user with a list of the available access devices 120 and ready to facilitate a payment transaction. The user may then select one of the access devices 120 based on his/her personal preference. For example, the user may select the access device 120 closest to him/her. In this example, three access devices are shown on the GUI: “Access Device 532,” located in Aisle 4, “Access Device 235,” located in Aisle 6, and “Access Device 155,” located in Aisle 1. The user may be able to identify the correct access device by, for example, looking at a label or other form of identification attached to the access device.

FIG. 7B shows an exemplary interface on an access device 120 for confirming a secure file transfer with a communication device 110 over a secure file transfer protocol, in accordance with some embodiments of the invention. After the user may have selected the appropriate access device for carrying out the transaction via the payment application on the on the user's communication device 110, the access device 120 may display (via output device 318) a prompt indicating that a secure file transfer protocol connection has been established with the communication device 110. The prompt on the access device 120 may ask the user to confirm whether he/she wishes to accept the data transfer (e.g., transfer of the payment credentials) from the communication device 110. In addition, the access device 120 may display the name of the communication device that the secure communication has been established with. Thus, the user may be able to verify that he/she is at the correct access device 120 and that the access device 120 is communicating with the correct communication device 110. If the user wishes to carry on with the transfer of the payment credentials, the user may select the “ACCEPT” button by either touching the display (e.g., output device 318) or using a another input device such as a keypad. On the other hand, if for any reason the user wishes not to carry on with the transfer of the payment credentials, the user may select the “CANCEL” button. In some embodiments, the access device 120, if configured to do so, may simply accept any incoming secure data transfer without displaying a confirmation prompt.

The various participants and elements described herein with reference to FIGS. 1-7B may operate one or more computer apparatuses to facilitate the functions described herein. Any of the elements in FIGS. 1-7B, including any servers or databases, may use any suitable number of subsystems to facilitate the functions described herein.

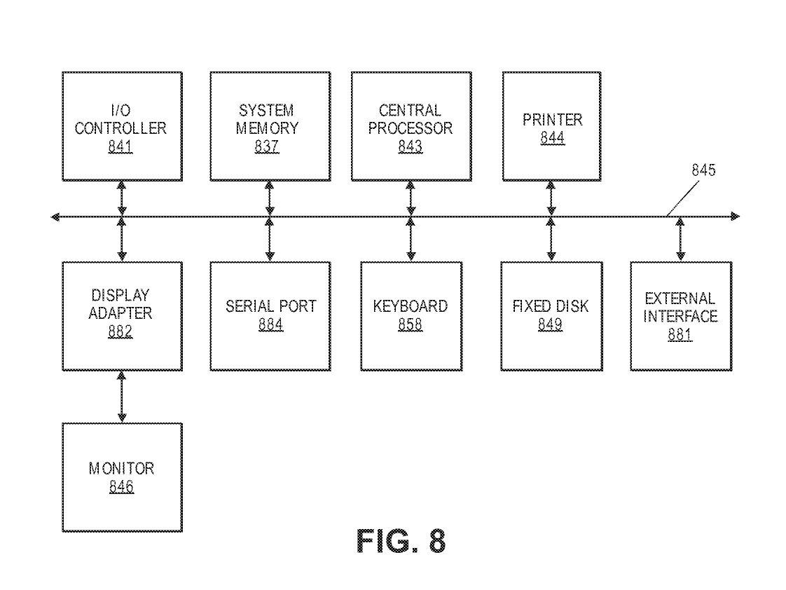

Examples of such subsystems or components are shown in FIG. 8. The subsystems shown in FIG. 8 are interconnected via a system bus 845. Additional subsystems such as a printer 844, keyboard 858, fixed disk 849 (or other memory comprising computer readable media), monitor 846, which is coupled to display adapter 882, and others are shown. Peripherals and input/output (I/O) devices, which couple to I/O controller 841 (which can be a processor or other suitable controller), can be connected to the computer system by any number of means known in the art, such as serial port 884. For example, serial port 884 or external interface 881 can be used to connect the computer apparatus to a wide area network such as the Internet, a mouse input device, or a scanner. The interconnection via system bus allows the central processor 843 to communicate with each subsystem and to control the execution of instructions from system memory 837 or the fixed disk 849, as well as the exchange of information between subsystems. The system memory 837 and/or the fixed disk 849 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for facilitating a user transaction, comprising:
selecting, via a communication device, an access device;
establishing, via the communication device, a secure connection to the access device using a secure file transfer protocol supported by a wireless data protocol; and
transmitting, via the communication device, a payment credential from the communication device to the access device using the secure file transfer protocol.

2. The method of claim 1, wherein the secure file transfer protocol is an ad-hoc service supporting transport layer security (TLS).

3. The method of claim 1, wherein the secure file transfer protocol is a device manufacturer specific protocol supporting transport layer security (TLS).

4. The method of claim 1, wherein the payment credential is a payment token.

5. The method of claim 4, further comprising:
generating a hash value using a hashing algorithm and a user password; and
encrypting, by the communication device, the payment token using the hash value generated from a user password.

6. A communication device comprising:
a processor;
and a computer readable medium coupled the processor, the computer readable medium comprising code, executable by the processor, for implementing a method comprising
selecting an access device;
establishing a secure connection to the access device using a secure file transfer protocol supported by a wireless data protocol; and
transmitting a payment credential from the communication device to the access device using the secure file transfer protocol.

7. The communication device of claim 6, wherein the secure file transfer protocol is an ad-hoc service supporting transport layer security (TLS).

8. The communication device of claim 6, wherein the secure file transfer protocol is a device manufacturer specific protocol supporting transport layer security (TLS).

9. The communication device of claim 6, wherein the payment credential is a payment token.

10. The communication device of claim 9, wherein the method further comprises:
generating a hash value using a hashing algorithm and a user password; and
encrypting, by the communication device, the payment token using the hash value generated from a user password.

11. A method for facilitating a user transaction, comprising:
broadcasting, via an access device, a communication indicating connection readiness using a wireless data protocol;
in response to a request from the communication device, establishing, via the access device, a secure connection to the communication device using a secure file transfer protocol supported by the wireless data protocol; and
receiving, via the access device and from the communication device, a payment credential via the secure file transfer protocol.

12. The method of claim 11, wherein the secure file transfer protocol is an ad-hoc service supporting transport layer security (TLS).

13. The method of claim 11, wherein the secure file transfer protocol is a device manufacturer specific protocol supporting transport layer security (TLS).

14. The method of claim 11, wherein the payment credential is a payment token.

15. The method of claim 14, wherein the token is encrypted using a hash value generated from a user password associated with a digital wallet application on the communication device.

16. An access device comprising:
a processor, and
a computer readable medium coupled the processor, the computer readable medium comprising code, executable by the processor, for implementing a method comprising
broadcasting, via the access device, a communication indicating connection readiness using a wireless data protocol,
in response to a request from a communication device, establishing, via the access device, a secure connection to the communication device using a secure file transfer protocol supported by the wireless data protocol, and
receiving, via the access device and from the communication device, a payment credential via the secure file transfer protocol.

17. The access device of claim 16, wherein the secure file transfer protocol is an ad-hoc service supporting transport layer security (TLS).

18. The access device of claim 16, wherein the secure file transfer protocol is a device manufacturer specific protocol supporting transport layer security (TLS).

19. The access device of claim 16, wherein the payment credential is a token.

20. The access device of claim 19, wherein the token is encrypted using a hash value generated from a user password associated with a digital wallet application on the communication device.
